(19) United States
(12) Patent Application Publication
(10) Pub. No.: US 2005/0254927 A1
(43) Pub. Date: Nov. 17, 2005

(54) Portable transporting apparatus

(76) Inventors: James Swetman, Fairport, NY (US); Henry Stanton, East Rochester, NY (US); Steven Mertz, Rochester, NY (US)

Correspondence Address: BASCH & NICKERSON LLP, 1777 PENFIELD ROAD, PENFIELD, NY, 14526, US

(21) Appl. No.: 11/128,798

(22) Filed: May 13, 2005

Related U.S. Application Data
(60) Provisional application No. 60/571,768, filed on May 17, 2004.

(51) Int. Cl. B60P 1/00

(52) U.S. Cl. 414/542

(57) ABSTRACT

Disclosed is a method and transporter for lifting, moving and installing heavy and bulky loads such as machinery, equipment and appliances. The transporter comprises a frame for straddling the load; Once a first end of the load is attached to the transporter; a suspension member or similar device is affixed to the load and tightened relative to a handle of the frame to suspend the opposite end from the frame using the suspension member. The handle of the frame may then be used to lift the load, balance it on the wheels and permit a single user to safely and comfortably transport the load. Also disclosed is transporter having jacks for lifting a load onto a chassis having three or more wheels, at least one of which is steerable.

### PRIORITY CLAIM

This application claims the benefit and priority from U.S. Provisional Application Ser. No. 60/571,768 filed on May 17, 2004 for a “Versatile Portable Transporter,” by Swetman et al., which is hereby incorporated by reference in its entirety. Cross reference is made to the concurrently filed application for a “Portable Transporting Apparatus”, filed on even date herewith by Swetman et al.

This invention relates generally to an apparatus for use in lifting and transporting heavy machinery during installation, and more particularly to a collapsible frame transporter that, once assembled, will accommodate the transporting of loads having a variety of sizes, and which is easily assembled and disassembled for portability and storage.

### BACKGROUND AND SUMMARY

Many types of wheeled transporters such as carriages, hand trucks and transporters are known for manually transporting heavy loads. Most notable, relative to the present invention, are those devices that are specifically designed for transporting and maneuvering a jet ski or snowmobile on dry land. While well suited for the specific purpose of moving recreational vehicles, such as U.S. Pat. No. 6,244,603, these devices are restricted to a specific application and are further limited by the requirement to have the lift or contact point in direct proximity of the wheels in order to have sufficient mechanical advantage to raise the vehicle off the ground. As a result, the load forward of the wheels is freely extended beyond the center of gravity in an unsupported manner and, therefore, is relatively unsecured. In an attempt to improve the stability, and safety, U.S. Pat. No. 5,716,061 moves the lift point a distance away from the wheels and provides for an intricate hydraulic mechanism to engage a snowmobile and lift it onto a carriage for transporting.

The transporting of a heavy load, such as appliances or machinery, can be cumbersome in certain situations due to the work setting. Recently, there has been a significant increase in the demand for residential emergency generators, (hereafter referred to as a REG). Installation of a REG in an established and landscaped residential setting presents numerous challenges to the installer, who often is a licensed electrician or other skilled tradesman. For example, transporting and installing a REG is labor intensive due to the size and weight of the generator and the adverse surrounding environment. A residential generator is bulky and can weigh approximately 500 pounds, or more, and is generally placed in an obscure location having limited access. Due to the shear mass of a REG, installers will often have it directly shipped to the residence of the customer. However, the freight service typically will not place the generator in the designated installation location; nor would one want it placed there without the proper foundational materials being deposited beforehand. Accordingly, the generator must be manually lifted, moved to, and positioned, on the prepared site.

While it is well known to use a cart or appliance carriage to transport heavy or bulky loads, no devices were known to specifically assist in the lifting, transporting and positioning of a bulky object, such as a REG. Additionally, the prior art fails to provide a positive engagement of the load, to prevent it from moving relative to the transporting device, whereas the present invention provides for a restraining system in order to secure the load to the transporter in both the horizontal and vertical directions. Securing a load within a portable transporting apparatus is an important safety consideration, which all too often is overlooked, particularly where the transporting apparatus is to be used on uneven and sloped terrain.

Preventing back injuries is also a major workplace safety challenge. According to the Bureau of Labor Statistics, more than one million workers suffer back injuries each year, and back injuries account for one of every five workplace injuries. No approach has been found for eliminating back injuries caused by lifting, though it is felt that a substantial portion can be prevented by the availability and effective use of mechanical aids such as portable handling equipment.

Consequently, it was often the case that to move the REG to its installation location required the installer to have four or more laborers to handle the load, or in the alternative, it would require the use of power driven equipment to move and place a REG onto its pad. Clearly, both of these alternatives result in increased labor and overhead costs to safely install a REG. Moreover, the use of automated equipment such as skid steer and front-end loaders, forklifts and the like require additional materials (plywood, planking, etc). to reduce damage to the landscape caused by such equipment. Furthermore, to compensate for the higher installations costs when using a forklift, loader or a like, an installer must compromise the profit margin on each installation or charge a higher installation price to the customer, which would increase the installer's exposure to competition.

Therefore, an unmet need exists for a device that significantly improves the mobility of heavy loads, such as a REG, in an outdoor residential setting, so that installation can be facilitated by a single technician, in lieu of a multiple laborers, or in the alternative powered equipment. Moreover, it is desirable to have a versatile device that is adjustable to accommodate loads of various dimensions and weights as well as a multitude of terrains. Furthermore, it is desirable to have a transporter that is easily assembled and disassembled to permit ease of storage, handling and mobility.

One aspect of the present invention is directed to a transporter comprising: a frame, said frame including at least one handle and a left side member and a right side member, said handle being connected to said left and right side members; said left and right side members each having a top section, a central section to which a wheel is attached for contact with a supporting surface, and a bottom section extending outwardly therefrom in a direction opposite the handle; a securing member attached to at least the bottom section, wherein said securing member secures a load at a location adjacent a first side of the load; and a suspension member, said suspension member having one end connected to an opposite side of the load and a second end connected to said frame so as to lift the opposite side of the load off the supporting surface when said handle is raised.

Another aspect of the present invention is a portable transporter for moving a load, comprising: a frame, said frame including at least one handle and a left and right side member, said handle being operatively connected to said left and right side members, and said left and right side members each having a top section, a central section and a bottom section extending in a generally perpendicular direction relative to said central section; at least one wheel rotatably attached near the distal end of said central section of each left and right side member; at least one through hole located in the bottom section of each left and right side member; a securing rod fitting within said through hole in the bottom sections of the left and right side members in order to engage the load and a suspension member attached between said handle and an opposite side of the load.

Yet another aspect disclosed herein is a method of transporting a load, comprising: straddling a transporter over a load, said transporter including opposed side members, each side member being attachable to a handle, and each having an axle extending outwardly from a center portion thereof with a wheel rotatably affixed thereto, and a generally horizontal bottom member extending therefrom; securing the bottom section of each side member of said transporter to the load at a position proximate a first side of the load; forcing the handle of said transporter downward to cause the transporter, and causing the transporter to pivot about the axles and to raise the first side of the load; affixing a suspension member between an opposite side of the load and the handle of the transporter frame, so as to support the opposite side of the load from the frame using said suspension member; and lifting the handle so as to generally balance the load on the wheels, thereby permitting an operator to transport the load with a reasonable effort.

The transporter may also be used to move supplies whereby the load is supported on a platform, and the load includes excavation materials, as well as foundation materials such as gravel, mulch, sand, dirt or similar leveling materials as well as retaining materials such as lumber and cement blocks. In this application a platform is secured within the transporter so as to support and carry the aforementioned supplies to the installation site.

A further aspect of the present invention relates to transporting a heavier load. For example, a water-cooled residential emergency generator, (hereafter referred to a WCREG) or an air-conditioning unit, for example, may exceed 1,000 pounds. As previously discussed the requirements of a residential installation environment offer a significant impediment to the installation of large equipment, such as a WCREG. Accordingly, a device comprising three or more wheels and having an integrated lifting mechanism is advantageous for the heavier loads exceeding about 800 pounds. In this case, the operator is not required to straddle and balance a load over a single axle. In the alternative embodiment, the operator(s) install a lifting frame having wheels about the load, where the load is vertically displaced relative to the wheels by two or more leverage devices or actuators. Once elevated, the load clears the supporting surface, which allows the load to be rolled about on the truck having three or more wheels. Moreover, once raised, to move the heavier load only requires that the operator push or pull the load in order to overcome the rolling resistance caused by the mass of the WCREG.

Accordingly, the further aspect disclosed herein is a truck for lifting and moving a heavy load comprising: a chassis, including a first side lifting rail and an opposed second side lifting rail and at least two carriages removably attached to opposite each ends of said side lifting rails; said carriages each having an axle with at least one wheel rotatably attached thereto; at least one carriage having a steering mechanism operatively connected thereto; and at least one swing arm attached to each of the axles whereby a force applied to said swing arm vertically displaces the lifting rails relative to the axles so as to cause a load to be supported by the wheels for transporting.

A further aspect disclosed herein is a method and apparatus for the installation of a REG. The method for the installation of a generator, comprises: delivering a generator using a delivery vehicle having a gantry mounted thereon, said gantry including and extendable boom and a movable winch connected thereto, said winch being suitable for connecting to the generator; lifting the generator off of a surface of the delivery vehicle with the winch; extending the boom and moving the generator to a point clear of the vehicle; using the winch, lowering the generator onto a surface; assembling a generator transporter about the generator; using said transporter, moving generator to an installation site; and causing the transporter to lower the generator onto a foundation and thereby permit the generator to be separated from the transporter.

### BRIEF DESCRIPTION OF THE DRAWINGS

The present invention may take form in various embodiments, components and arrangements of components, and in various steps and arrangements of steps. The drawings are only for purposes of illustrating an embodiment and are not to be construed as limiting, wherein:

FIG. 1 is a perspective view of one embodiment of the invention;

FIG. 2 illustrates an embodiment of the invention in use with a load;

FIG. 3 is a partial view of a suspension member take-up mechanism;

FIG. 4 is an alternative embodiment of the invention in use with a support bar and cargo strap;

FIG. 5 is a view similar to FIG. 4 using more than one support bar;

FIG. 6 a perspective view of the ground clearance of the load;

FIG. 7 is a view of the disassembled components of the embodiment of FIG. 1;

FIG. 8 is a view of the disassembled components prepared for storage;

FIG. 9 is a diagram showing the relative forces acting on the embodiment of FIG. 1;

FIG. 10 is a perspective view of a gantry-mounted boom within a van in accordance with an aspect of the invention;

FIG. 11 is a perspective view of the gantry boom in the extended position;

FIG. 12 is a view of the transporter and gantry in use;

FIG. 13 is a view of an alternative, three-wheel transporter embodiment;

FIG. 14 is a perspective view of the three wheel transporter components;

FIG. 15 is a perspective view of the steering carriage of the transporter in FIG. 13;

FIG. 16 is a perspective view of the rearward carriage of the transporter in FIG. 13; and

FIG. 17 is a flow chart illustrating the basic steps for delivery and installation of a generator in accordance with an aspect of the disclosed invention.

### DESCRIPTION OF THE PREFERRED EMBODIMENT

The methods and apparatus will be described in connection with various embodiments, however, it will be understood that there is no intent to limit the invention to the embodiments described. On the contrary, the intent is to cover all alternatives, modifications, and equivalents as may be included within the spirit and broad scope of the disclosure as defined by the appended claims.

For a general understanding of the present invention, reference is made to the drawings. In the drawings, like reference numerals have been used throughout to designate identical elements. It is also noted that the various drawings illustrating the present invention are not to scale and that certain regions may have been purposely drawn disproportionately so that the features and concepts of the present invention could be properly illustrated.

As noted above, the present invention is directed to a portable transporting apparatus for lifting, transporting and installing a bulky load. The transporting apparatus can be utilized for a variety of loads including home generators, heat pumps and air conditioning units, swimming pool filters, yard sculptures or furniture, and any other article that is difficult to lift, transport and install due to its weight and/or size. The embodiments are described with respect to lifting, transporting and installing a residential emergency generator (REG), although, as noted herein, the invention is not intended to be limited to use with REGs unless so indicated.

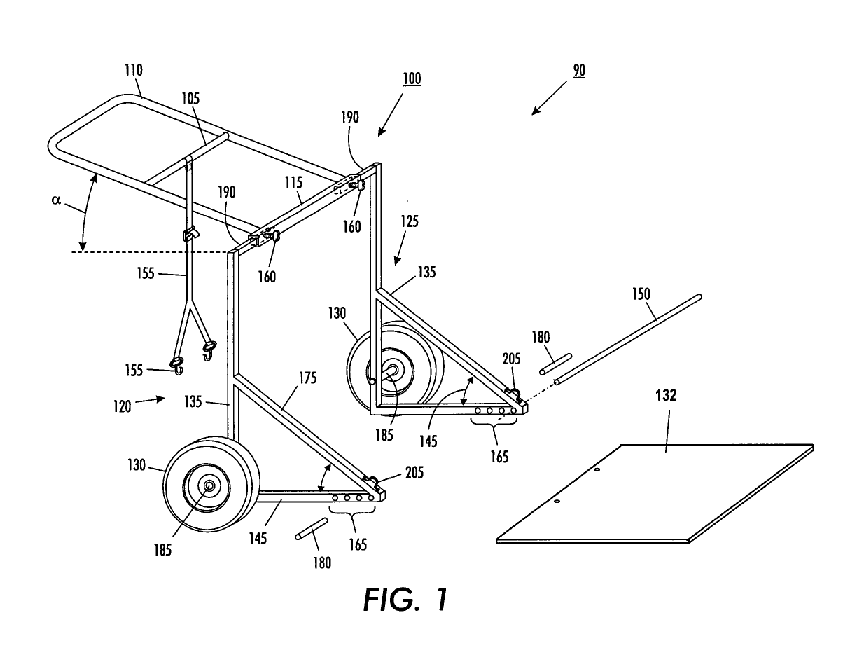

Referring to FIG. 1, there is illustrated a perspective view of an embodiment of the present invention. As shown, frame 100 of transporter 90 comprises a handle 110, which includes at least one cross member 105. The handle connects left side member 120 and right side member 125. The transporter further includes a securing means comprising suspension member 140, and a mounting member in the form of a securing rod 150. In another embodiment, platform 132 may be placed between suspension member 140 and securing rod 150 to support and transport a load comprising of supplies and tools. Using the platform, the transporter may be used to move supplies whereby the load is supported on a platform, and the load includes excavation materials, as well as foundation materials such as gravel, mulch, sand, dirt or similar leveling materials as well as retaining materials such as lumber and cement blocks. In this application a platform is secured within the transporter so as to support and carry the aforementioned supplies to the installation site. The platform may be formed of wood, steel or similar materials suitable for supporting the load, and preferably manufactured so as to enable the platform to be easily stored and transported.

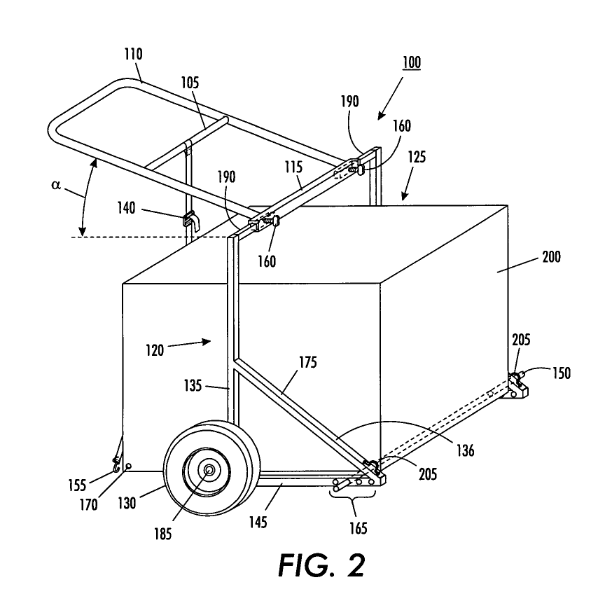

Handle 110 is operatively engaged to the left and right side members 120 and 125 respectively by way of coupling assembly 115 in handle 110. In one embodiment, as depicted in FIG. 1, coupling assembly 115 is designed to receive a similarly-shaped top section 190 of each of the left and right side members 120 and 125. Suspension member 140 may be a fixed strap, or may also include a buckle, clamp or similar means to adjust and “lock” the strap to a specific length. Additionally, while suspension member 140 is depicted as a flexible strap connected to the handle of the frame (and then to an end of the load as in FIG. 2), there are equally effective restraint devices that may be considered alternatives to a flexible strap, including chains, cables, ropes, hinged rigid members and the like.

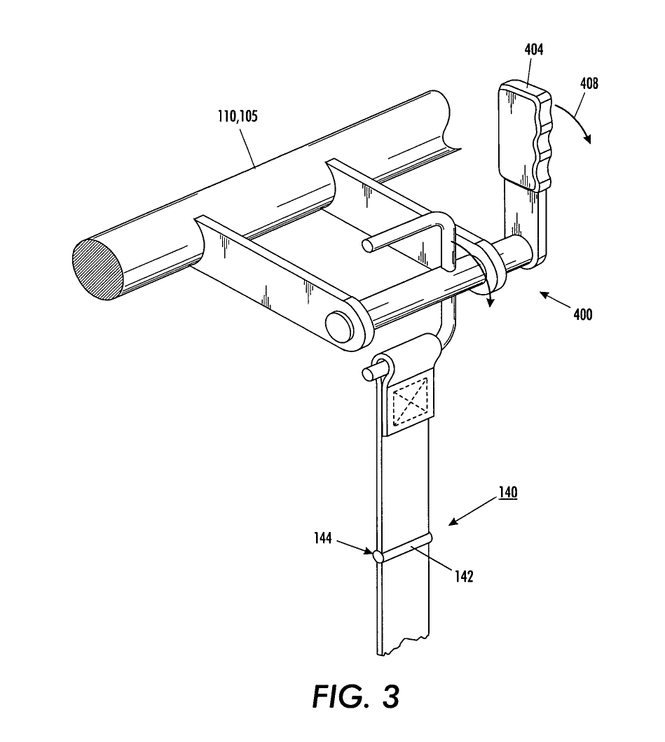

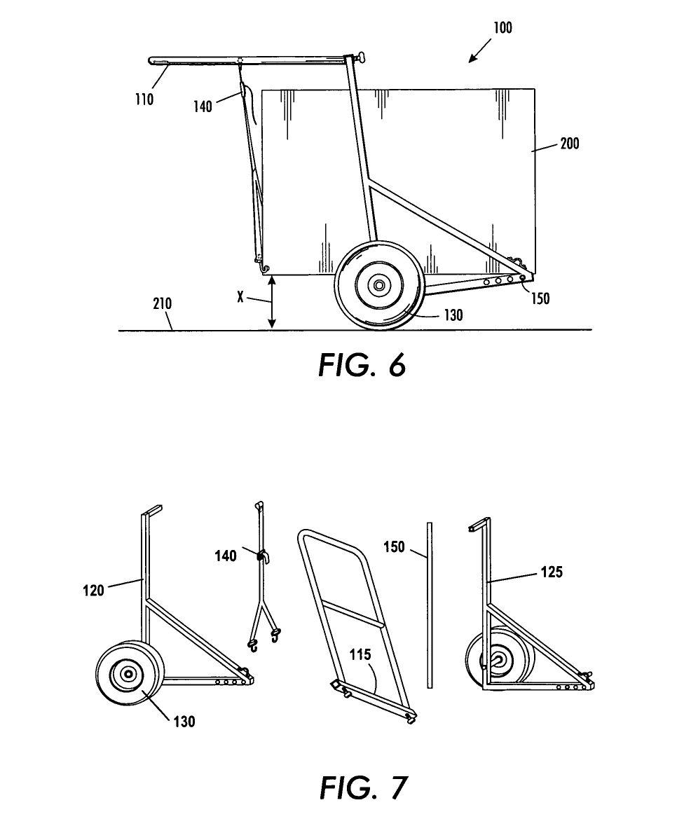

In yet another alternative, depicted in FIG. 3, suspension member 140 may take the form of a strap or a rigid or semi-rigid member 142 having one or more hinge points 144, and being connected to a lever assembly 400 associated with the handle 110 or cross bar 105. Upon actuation of the lever arm 404, in the direction indicated by arrow 408, the assembly rotates and the length of suspension member 140, relative to handle 110, is shortened to allow a load (not shown) to be suspended above supporting surface 210, as depicted in FIG. 6. As will be appreciated assembly 400 may also take the form of a ratchet system used to wrap or wind a flexible suspension member 140 thereabout.

Returning to FIG. 1, the left and right side members each have a top section 190 slidably engaged within coupling assembly 115 and thereby operatively connected to the handle 110 so as to permit top section 190 to “telescope” in and out of coupling assembly 115 of handle 110. As will be appreciated the nature of the telescoping sections (handle in combination with left and right members) permits the apparatus to accommodate various widths of load 200. Each side member also has a central section 135 with a wheel 130 rotatably attached to the lower end thereof on axel 185 which, as depicted, extends outward from the side member. Each side member further includes a bottom section 145 extending at an angle from central section 135 so as to be in a generally horizontal or slightly upward orientation when the transporter is in use. Bottom section 145 may be connected to central section 135 by welding or fasteners, and a reinforcing member 175, a gusset, or similar means may be used to provide a rigid connection between central section 135 and lower section 145.

As noted above, various components of the frame 100 may be constructed from a variety of materials and shapes in the form of channels, tubing and/or flat or bar stock. Materials may be selected from the group including steel, aluminum, brass, copper, wood, polycarbonates, polypropylenes or fiberglass. The frame 100 has been designed to be economically manufactured by conventional fabrication methods and materials (e.g., welding, brazing, riveting of metal components). The wheels 130 are commercially available and can be made of a solid material or contain an inflatable pneumatic outer section for compliance with the ground, and may be of a variety of cross sectional profiles and diameters to accommodate various loads and terrains. It is further contemplated that alternative ground-contacting means may be employed, such as skis, rails, tracks and the like depending upon the type of surface to be traversed with the load. It is also contemplated that in addition to being manually moved, one or more wheels or the like may have a drive mechanism associated therewith to aid in the movement of the transporter (e.g., up a hill or slope) much in the same manner as powered wheel-barrows.

In one embodiment of the invention, the wheel 130 is a 16-inch pneumatic tire, which is considered to be of sufficient size to allow for the transport of a load over a variety of terrains including gravel, grass, dirt and pavement. In the embodiment shown in FIG. 1, the suspension member 140 comprises an adjustable strap or similar means attached to frame 100 at crossbar 105 on handle 110 of transporter 90. Suspension member 140 may include a separate strap having hooks 155 on the distal ends to engage rear lift points 170 of load 200. Although suspension member 140 is depicted as a flexible fabric strap (e.g., nylon), it is contemplated that various alternatives may be employed, including chains, cables, ropes and the like. FIG. 2 illustrates how hooks 155 may be engaged at rear lift point 170 to suspend a REG within frame 100 of the transporter 90. A rigid securing rod 150 is positioned to pass beneath the generator or through an existing orifice such as a hole, channel or eye-hooks on or near the forward side of the generator (perhaps passing within the chassis of the generator). The securing rod 150 also is placed through one of the support member receiving holes 165 in the distal end of bottom section 145 of left/right side member 120 and 125 respectively. A REG and other pieces of heavy machinery often come equipped with lifting holes or lugs suitable for attaching hooks 155 as well as for inserting securing rod 150. One advantage of the transporter 90 is the ability of the securing rod 150 being actively engaged within the chassis of the REG to prevent shifting of the REG relative to the transporter. However, in the event that load 200 does not include pre-drilled holes, eye-hooks or similar devices, securing bar 150 may pass beneath load 200 in order to facilitate the intended purpose of the present invention. Additionally if no lifting holes are provided, the load may be strapped or secured to the securing rod to assure the load does not shift significantly while transporting.

As depicted in FIG. 2, suspension member 140 is an adjustable lift strap or a variable length solid member having a cinching means that provides a sufficient length to engage and suspend the rear most portion of load 200. FIG. 6 makes note of the fact that the indicated distance X between supporting surface 210 and load 200 is a function of the length of suspension member 140 as the load is rotated about securing rod 150 when suspension member 140 is adjusted.

Securing rod 150 can be constructed in either a circular or square cross section from a variety of materials including; steel, aluminum, brass, copper, wood, polycarbonates, polypropylenes or fiberglass. Although depicted as a contiguous bar, it is further contemplated that the function of securing rod 150 may, in an alternative embodiment, be achieved with two separate bars such as a pair of steel pegs 180, each passing through one of holes 165 and extending inward to engage the holes or other lifting features of the REG, or possibly inserted underneath the load. The removable securing rod 150 or pegs 180 may be held in place by the use of at least one spring-pin, clip, clamp, cotter key or other similar fastener to prevent it from sliding out and becoming disengaged from load 200 and/or bottom section 145.

Considering, again, the embodiment of FIG. 1, the plurality of through-holes 165 in bottom section 145 of each member provide for variable placement of the securing rod 150 so as to generally locate the balance point of load 200 near the wheels 130. The position of securing rod 150 and the length of suspension member 140 are adjustable so as to enable load 200 to be generally slung and balanced over axle 185 of wheels 130 such that load 200 may be lifted and transported by a single operator when a reasonable force is applied to handle 110.

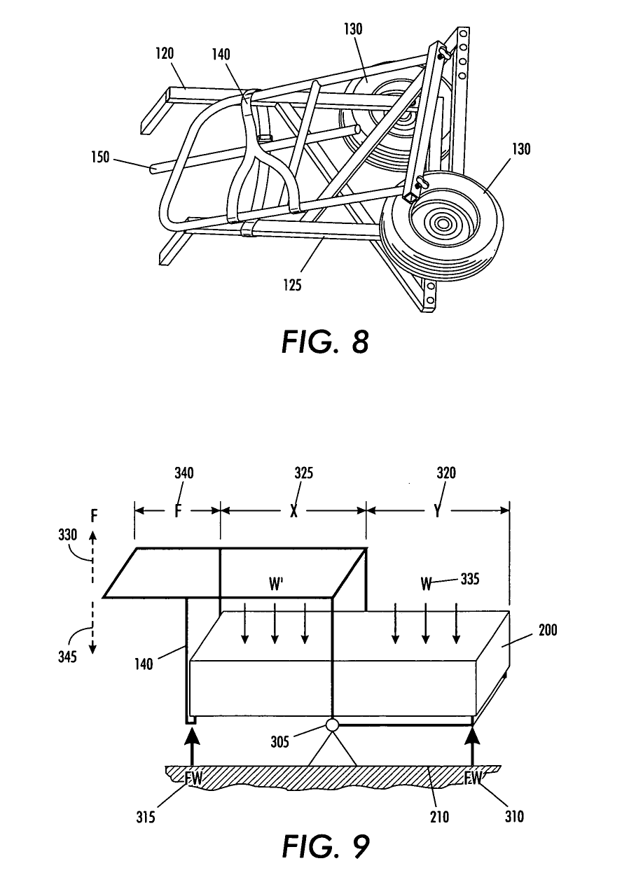

Continuing with reference to FIG. 1, handle 110 is depicted as being attached to the left and right side members by coupling assembly 115 and locking screws 160. Attachment in this manner allows for the adjustment of the width between the left and right side members in order to accommodate loads of different sizes. Additionally, this configuration provides for disassembly and storage of frame 100 by disengaging top section 190 of the left and right side members from handle 110 as presented in FIG. 8. It will be appreciated that various alternatives to the locking bolts may be used to momentarily attach the handle and the side members of the frame together, including clevis pins, spring-loaded buttons, clamps, a collet and a like.

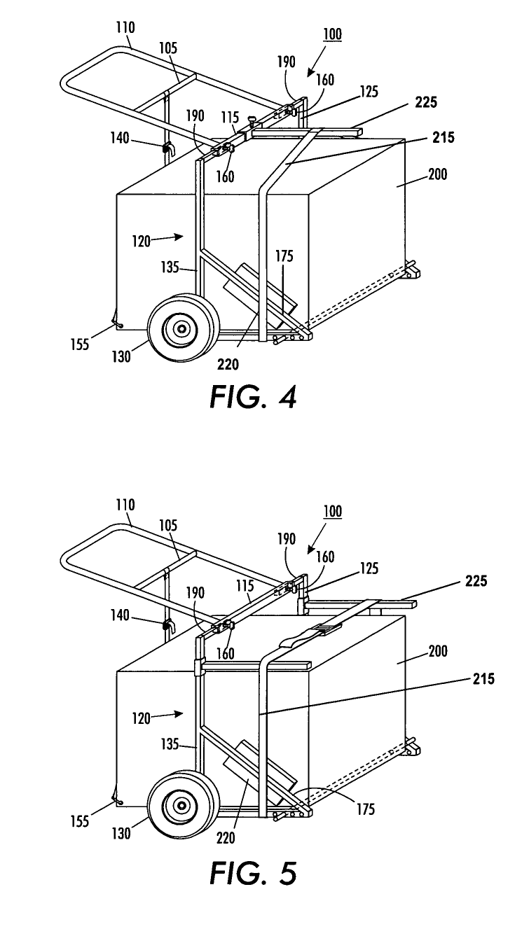

Referring next to FIG. 4, there is shown an alternative securing method where cargo strap 215 and pads 220 are used to clamp load 200 between reinforcing members 175 of the left and right side members, 125 and 120 respectfully. In this configuration cargo strap 215 is passed underneath load 200 and over support bar 225 whereas cargo strap 215 is tightened to provide a firm containment of the forward portion of load 200 as it is suspended from above by support bar 225. This method is particularly advantageous where lifting holes or lugs are not provided within the load. The rear portion of load 200 is again lifted with suspension member 140, however hooks 155 may be engaged on the underside of load 200. FIG. 5 shows yet another embodiment using the aforementioned method of securing the forward portion of load 200, however in order to prevent the overloading of a single support bar 225 the load is now distributed over at least two support bars 225. Moreover, support bars 225 may be permanently mounted or welded to the center section 135 of each right and left side member or they may be adjustably attached to the center sections.

Next, FIG. 7 shows the transporting apparatus in a dissembled and portable state, whereby both side members 120 and 125 have been disengaged from coupling assembly 115 of handle 110. It is anticipated that suspension member 140 can also be used to bundle the separate components into a single package for storage, as demonstrated in FIG. 8. Wheels 130 may also be detached from their respective side frame members by removing a retainer clip or pin on axle 185 to reduce the overall size and weight of the collapsed transporting apparatus.

Referring once again to FIGS. 1 and 2, bottom section 145 of right side member 120 is substantially perpendicular to center section 135, however handle 110, is attached at an oblique angle relative to center section 135. This offset angle allows for handle 100 to be predominately parallel to the ground as the operator lifts and moves load 200. It will be further appreciated that the included angle (a) is somewhat dependent upon the particular application and the stature of the operator. Accordingly, it will be appreciated that it may be desirable to be able to adjust the angle of the handle (a) relative to the side members. It is also possible that handle 110 is made in the form of a T-shaped handle, with a central member extending outward, as opposed to a pair of side members as shown in the illustrated embodiment.

A general characterization of the forces operating on the transporter are represented in FIG. 9, which shows in schematic form a first class lever having a moment X and Y about fulcrum 305. One objective of the present invention is to establish a center of mass located near the fulcrum point 305. The equilibrium equation might be represented in ft-lbs as FW′ (X)=FW (Y) whereby FW is the reactive force to load 335 and X or Y is the distance from the fulcrum 305. It is believed desirable for the load to be supported so that the position of the center of mass of load 200 is slightly forward of fulcrum 305, where FX>FY. This positioning allows for a nominal downward force 345 to be applied so that suspension member 140 may be attached to the load to provide reactive force 315. Once connected the unbalanced load 335 is balanced or countered by a person applying a force 330 on the handle so as to suspend and move the load with minimal effort using wheels 130 (FIG. 1) attached at fulcrum 305. It should be noted that as the operator adjusts the length of suspension member 140 load 200 rotates about point 310 and thereby provides the desired ground clearance. An additional feature of this embodiment is the ability to limit the rolling motion once the operator releases force 330 on the handle so that load 200 comes into direct contact with the supporting surface 210, thereby limiting further motion by virtue of this braking action.

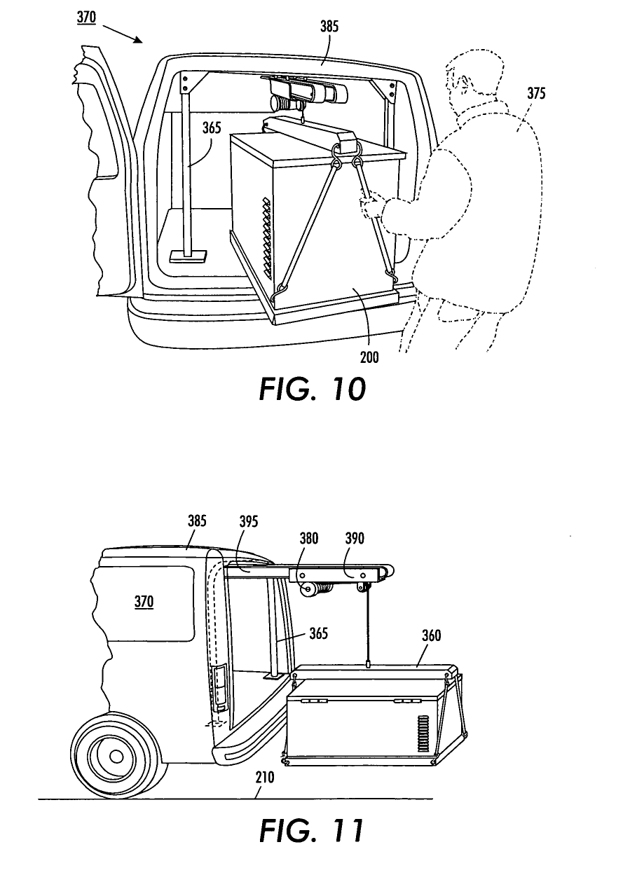

FIGS. 10, 11, 12 and 17 are now referred to with regard to a method of utilizing the transporter in delivering, lifting, transporting and installing a load such as a REG. FIGS. 10 and 11 show a vehicle-mounted gantry apparatus 370 to lift load 200 into and out of a bed, such as that of a conventional delivery van 385 or pickup truck. A lift comprises winch 380, affixed to a movable member or boom 390, and is slidably attached to parallel fixed member 395, having at least one supporting frame 365 secured to the bed.

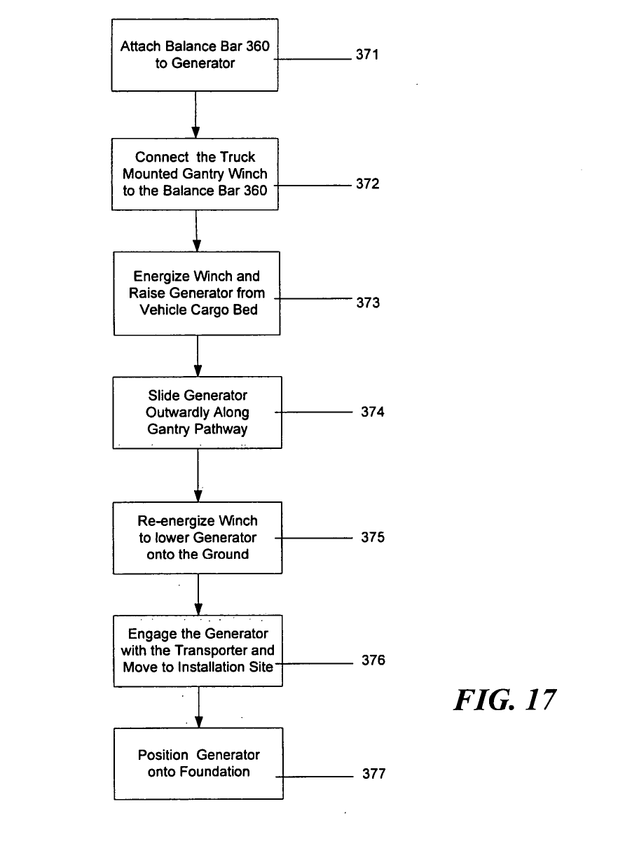

A method of using the vehicle-mounted gantry as diagramed in FIG. 17 includes attaching the load to the balancing bar 360, which is designed for connection to the ends or corners of the load while providing a central lifting point. Next, attaching winch 380 to load 200 using load-balancing bar 360, energizing winch 380 in a first direction, causes bar 360 and load 200 to move upward. Next the user would activate movable member 390 to laterally displace the load 200 in a second direction before re-energizing winch 380 in a counter-direction to lower the load onto a supporting surface.

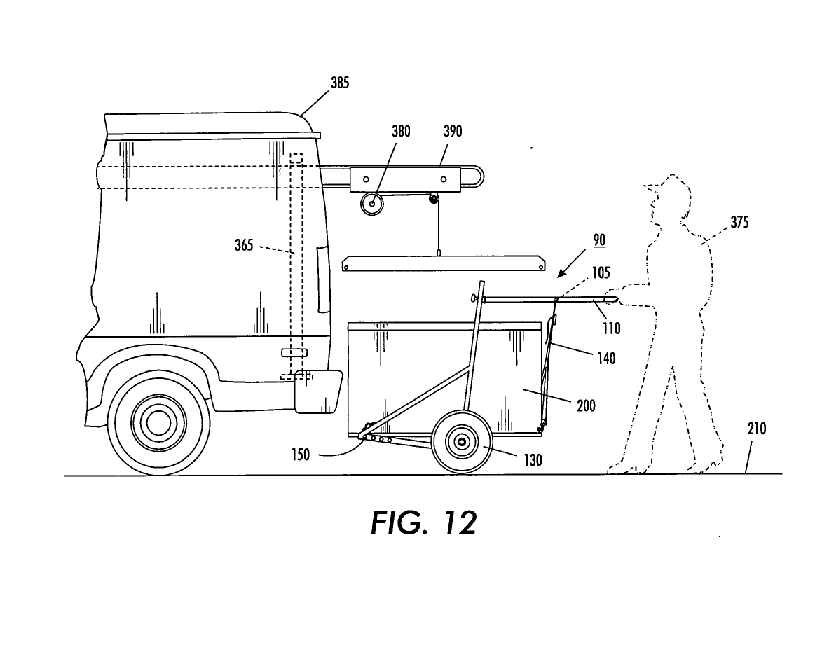

Now referring to FIG. 12, the assembled transporter 90 is placed about and over load 200, thereby straddling the load to be moved. Once this is accomplished by operator 375, securing rod 150 is inserted through the left and right side members so that securing rod 150 engages holes or eye-bolts on the load 200, or in the alternative is placed beneath the frontal end of load 200. The operator 375 then applies a force in the downward direction on handle 110 of frame 100. The application of this downward force causes the load 200 to pivot about securing rod 150, and moves the frontal end of load 200 away from the ground or supporting surface. The operator 375 may then attach suspension member 140 between load 200 and cross bar 105 in order to thereby suspend load 200 over wheels 130. Operator 375 can then lift handle 110 in an upward direction to cause load 200 to balance about wheels 130 and be lifted entirely off supporting surface 210. Subsequently, the operator may apply a lateral pushing or pulling force to move the load to the installation location. To disengage the load from the transporter, the aforementioned steps are simply reversed once the load is in position and the transporter can now be readily disassembled for storage as previously shown and described relative to FIGS. 7 and 8.

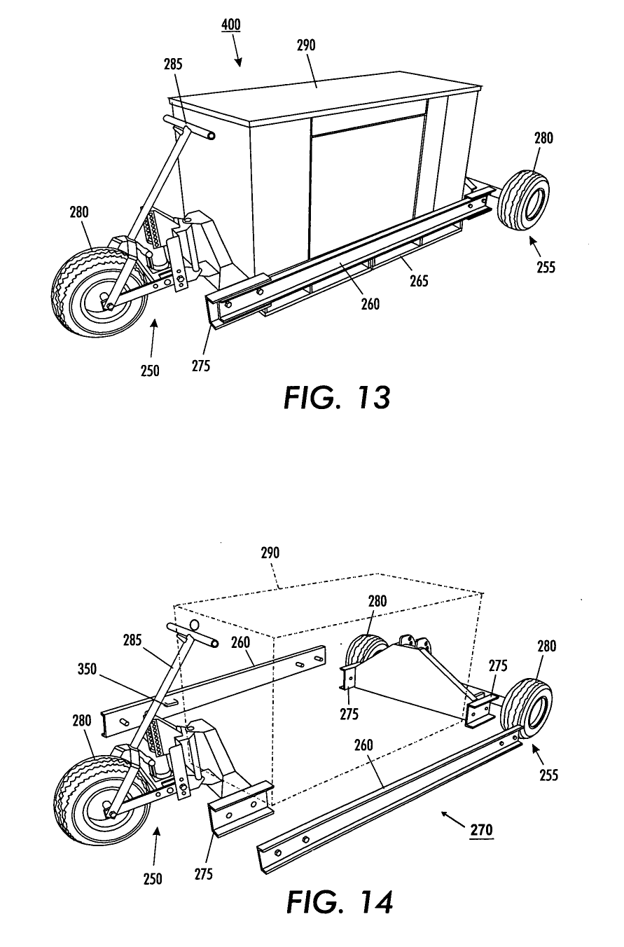

Referring now to FIGS. 13-16, FIG. 13 shows a transporter in the form of a portable transporting truck including a steerable carriage assembly 250, a dual wheel carriage assembly 255, a pair of lifting rails 260 and handle 285 or similar steering mechanism. Each carriage 250 and 255 further contain a mechanism for raising and lowering axle 300 having wheels 280 attached thereon. Load 290 is possibly substantially larger and heavier than the aforementioned load 200 and therefore may not be not compatible with the capacity of a single axle version of transporter 100. Typically load 290 is delivered to a residence mounted onto pallet 265 and has ports or a channel located within the base plate (not shown) of the WCREG for the purpose of lifting. Lifting rails 260 each contain at least one protrusion (likely two or more studs, pegs, or brackets) that are arranged so as to engage a base of the load once the lifting rails 260 are assembled into position.

As depicted in FIG. 14, the portable lifting chassis is placed around the perimeter of load 290. Steerable carriage 250 and carriage 255, having a fixed axle, are placed along the first adjacent sides of load 290 as a pair of lifting rails 260 are positioned parallel to each of the second adjacent sides of load 290 and subsequently inserted into lifting rail receivers 275 with protrusions 350 engaging the base plate channel of load 290. Next rails 260 are secured to either side carriage 250 and 255 to form a solid chassis for lifting and transporting and lowering load 290 on to a prepared installation site.

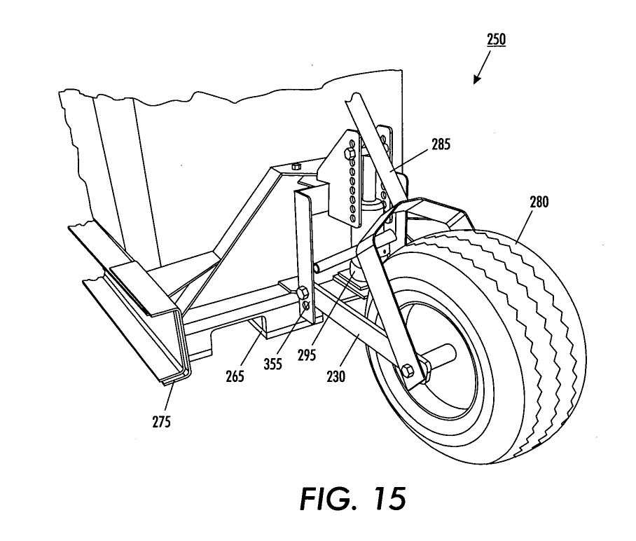

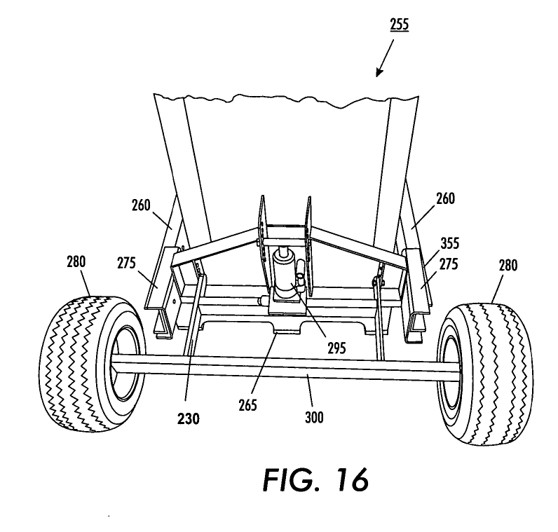

Steerable carriage 250, as shown in FIG. 15, has a pivotally connected wheel 280 providing a means to steer and direct the load along a specific route, typically over grass or dirt. Carriage 250 further contains an elevating mechanism whereby the rail receivers are raised and lowered, relative to wheel 280, by swing arm 230. Arm 230 is hinge mounted to pivot plate 355 and is acted upon by jack 295, or a similar lifting mechanism, to cause arm 230 to move in a substantially vertical arcuant path and thereby displacing wheel 280 away from pivot plate 355, which in turn alters the relative distance between lifting rails 260 and the supporting surface. In the load acquisition position swing arm 230 and jack 295 move chassis 270 downward until lifting rail receiver 275 is in direct contact with a supporting surface. Referring also to FIG. 16, carriage 255 also contains an elevating mechanism whereby the rail receivers are raised and lowered, relative to wheels 280, again by a swing arm 230 to rail receiver 275 and is acted upon by jack 295, or a similar lifting mechanism, to cause arm 230 to move in a substantially vertical arcuant path and thereby displacing wheels 280 relative to receiver 275, which in turn alters the relative distance between lifting rails 260 and the supporting surface. In the load acquisition position, swing arm 230 and jack 295 move chassis 270 downward until lifting rail receiver 275 is in direct contact with a supporting surface. The chassis 270, comprising rails 260 and carriages 250 and 255, is then assembled so as to rigidly engage load 290. The first and second jacks 295 are then extended to raise load 290 to above the pallet and/or supporting surface. Now the shipping pallet is removed and load 290 is mobile and able to be re-located to an installation location.

The lifting rails 260, in FIG. 14, are adjustably attached to said carriages 250 and 255 so as to enable the spacing between the carriages to accommodate varying load lengths. The carriages 250 and 255 are extendable as well so as to enable the spacing between the first and second lifting rails 260 to be adjusted to accommodate varying load widths. Once assembled, chassis 270, circumventing the perimeter of the load, should be in close contact with the load.

A brake (not shown) is provided in order to restrict the motion of load 290 on transporter or truck 400 when on an inclined surface or to stop motion. The brake may be reliant on friction at one or more of the wheels applying a brake shoe against a rotating surface. Additionally, a safety brake 235 may be incorporated into handle 285 whereby an attached braking member engages the ground or the tire 280 when handle 285 is lowered in an emergency. In one embodiment, the attached member can be a single spike like member (or a series of spikes) which engage the ground, much like a rake, to provide a reactive resistive force to the motion of truck 400.

The handle assembly 285 in FIG. 14 further consists of a cross bar sufficiently long, or adjustable, to allow more than one person to grasp the handle to maneuver the load. Handle 285 may also include a coupling means on the end thereof so that the handle may be used as a drawbar to connect the chassis to a tow vehicle. The coupling means may comprise an eye hook, a ball receiver, a chain, and a hole with a clevis pin or similar hitching means. The towing device may be a gas driven vehicle such as a garden tractor, an electric motorized vehicle (similar to a golf cart), a work animal or possibly a winch, come-along or block and tackle.

Returning to FIG. 13, truck 400 may also be motorized to accommodate adverse topography requiring a moving force in excess of the physical capabilities of the operators. In the event of a sloping terrain a rolling force is applied to one or more wheels, or axles attached thereto, by means of a motor drive consisting of a drive motor or engine and a power transmission capable of driving truck 400 at a speed of up to several miles per hour up a grade.

When not in use truck 400 is portable by virtue of at least four separate sections comprising a pair of lifting rails and carriages, each of which can be individually handled and stored independently. Moreover, it is contemplated that one or more pieces may be employed to provide a portion of the shipping container used for initial shipping and/or transport of the truck. Accordingly, the overall dimensions of truck 400 are reduced by a factor of about 4 to 1 or essentially a 75% reduced footprint from the assembled dimensions.

While this invention has been described with reference to various embodiments as described in detail above, it is evident that many alternatives, modifications, and variations will be apparent to those skilled in the art. Accordingly, it is intended to embrace all such alternatives, modifications and variations that fall within the spirit and broad scope of the appended claims.

1. A truck for lifting and moving a heavy load comprising:
a chassis, including a first side lifting rail and an opposed second side lifting rail and at least two carriages removably attached to opposite each ends of said side lifting rails;
said carriages each having an axle with at least one wheel rotatably attached thereto;
at least one carriage having a steering mechanism operatively connected thereto; and
at least one swing arm attached to each of the axles whereby a force applied to said swing arm vertically displaces the lifting rails relative to the axles to cause a load to be supported by the wheels for transporting.

2. The chassis of claim 1, wherein said steering mechanism includes at least one wheel rotatably mounted to an axle that is pivotally attached to the carriage.

3. The chassis of claim 1, wherein said lifting rails further comprising at least one protrusion extending inward there from, wherein said protrusion engage the load.

4. The of chassis claim 1, wherein the lifting rails are adjustably attached to said carriage assembly so as to enable the spacing between carriages to accommodate varying load sizes.

5. The chassis of claim 1, wherein the carriage assemblies are extendable to enable the spacing between the first and second lifting rails to be adjusted to accommodate varying load sizes.

6. The chassis of claim 1, wherein the wheels are pneumatic wheels.

7. The chassis of claim 1, wherein one or more wheels have a brake associated therewith.

8. The chassis of claim 1, wherein the handle includes a coupler for towing.

9. A method of transporting a load, comprising:
assembling a chassis around a load, said chassis including opposed side lifting rails, each lifting rail being attachable to a carriage, and each carriage having a swing arm to variably position an axle extending outwardly from the chassis having a wheel rotatably affixed thereon;
engaging the load with a protrusion within the first and second lifting rails;
activating a force applied to one or more swing arms in each carriage to vary the distance between a supporting surface and the chassis; and
applying a force to the handle of said carriage so as steer the load.

10. The method of claim 9, further comprising applying a driving force to at least one carriage.

11. The method of claim 10, wherein one or more wheels contain a brake.

12. A method for the installation of a generator, comprising:
delivering a generator using a delivery vehicle having a gantry mounted thereon, said gantry including and extendable boom and a movable winch connected thereto, said winch being suitable for connecting to the generator;
lifting the generator off a surface of the delivery vehicle with the winch;
extending the boom and moving the generator to a point clear of the vehicle;
using the winch, lowering the generator onto a surface;
assembling a generator transporter about the generator;
using said transporter, moving generator to an installation site; and
causing the transporter to lower the generator onto a foundation and thereby permit the generator to be separated from the transporter.
